(19) United States
(12) Patent Application Publication
(10) Pub. No.: US 2006/0168083 A1
(43) Pub. Date: Jul. 27, 2006

(54) Network alarm management system for managing event occurred in network element device and method for managing network alarm using the same

(76) Inventors: Seoung-Bok Lee, Seongnam-si (KR); Sun-Gi Kim, Seoul (KR)

Correspondence Address: ROBERT E. BUSHNELL, 1522 K STREET NW, SUITE 300, WASHINGTON, DC, 20005-1202, US

(21) Appl. No.: 11/282,611

(22) Filed: Nov. 21, 2005

(30) Foreign Application Priority Data
Dec. 15, 2004 (KR) 2004-106677

(51) Int. Cl. G06F 15/16

(52) U.S. Cl. 709/207

(57) ABSTRACT

A network alarm management system managing an event of an error occurring in a network. The system having a network element device outputting the event information to notify it to a manager and outputting detailed processing information to guide the manager responding to a processing guide-requesting signal transmitted from the manager regarding the event information; and an alarm management device receiving the output event information and calling the manager to voice-guide the manager, receiving and outputting the processing guide-requesting signal from the manager to the network element device, and receiving the detailed processing information corresponding to the processing guide-requesting signal from the network element device and thus voice-guiding the manager.

### CLAIM OF PRIORITY

This application makes reference to, incorporates the same herein, and claims all benefits accruing under 35 U.S.C. § 119 from an application for NETWORK ALARM MANAGEMENT SYSTEM FOR MANAGING EVENT OCCURRED IN NETWORK ELEMENT DEVICE AND METHOD FOR MANAGING NETWORK ALARM USING THE SAME earlier filed in the Korean Intellectual Property Office on 15 Dec. 2004 and there duly assigned Serial No. 2004-106677.

### FIELD OF THE INVENTION

The present invention relates to a network alarm management system, and more particularly, to a network alarm management system for managing an alarm and an event occurring in a network element device and a method for managing a network alarm using the same.

Generally, most of network element (NE) devices connected to an Internet, such as a router, switch, bridge, etc., are inter-worked from each other. Accordingly, when any one of the network element devices is out of order or in an abnormal situation, it can affect the entire network connected to the network device in which the failure or error occurred. Particularly, when a failure or operation error as described above occurs in a network device such as an Internet router apparatus, many devices connected to a lower network may not perform a routing. In this case, there is a worry that many Internet users cannot enjoy an Internet service.

Most network devices have diverse diagnosis and management systems to cope with the failure and abnormal operation error. However, many of the management systems according to the prior art have disadvantages, such that a system maintenance manager should center-monitor the systems through an alarm & event manager server such as a network management system (NMS) or the management or control is possible only at limited places such as a buzzer or emergency on-and-off light.

As an example of a network management server, a network element device in an Internet protocol (IP) environment may support a simple network management protocol (SNMP). Simple Network Management Protocol (SNMP) is the protocol governing network management and the monitoring of network devices and their functions. It is not necessarily limited to TCP/IP (Transmission Control Protocol/Internet Protocol) networks. SNMP is described formally in the Internet Engineering Task Force (IETF) Request for Comment (RFC) 1157 and in a number of other related RFCs.

Generally, a management server for managing an alarm and event may comprise an SNMP manager, and the network element device may consist of an SNMP agent.

The SNMP manager uses a “get” command for periodically checking an alarm state or event of the SNMP agent, i.e., the network element device.

At this time, the SNMP manager may obtain a value using an object identifier (OID: processed object information for performing a corresponding operation) table, in order to determine managed objects to be obtained using the SNMP “get” command.

The network element device can then manage specific objects that may be arranged in a management information base (MIB) database, which is a virtual information database. The MIB is meant by detailed processing information about a processed object for which a corresponding operation is performed.

A management information base (MIB) is a formal description of a set of network objects that can be managed using the Simple Network Management Protocol (SNMP). The format of the MIB is defined as part of the SNMP. (All other MIBs are extensions of this basic management information base.) MIB-I refers to the initial MIB definition; MIB-II refers to the current definition. SNMPv2 includes MIB-II and adds some new objects.

There are MIBs (or more accurately, MIB extensions) for each set of related network entities that can be managed.

In object-oriented programming (OOP), objects are the things you think about first in designing a program and they are also the units of code that are eventually derived from the process. In between, each object is made into a generic class of object and even more generic classes are defined so that objects can share models and reuse the class definitions in their code. Each object is an instance of a particular class or subclass with the class's own methods or procedures and data variables. An object is what actually runs in the computer.

The network element device, in response to requested MIB information through the SNMP “get” command from the SNMP manager, transmits values of an alarm and an event to conform to an MIB format to a notification filter of an application server provided to the network management server. Some alarms that are not important or can be ignored are filtered in the notification filter. However, important alarms or events or continued alarms are transmitted to an event correlator.

In the correlator, a correlation of the alarm and the event is examined. At this time, when there is a further necessary alarm or event, the SNMP manager again requests the MIB information from the network element device, which is an SNMP agent, using the “get” command.

Otherwise, when a predictable value or an emergency alarm or event occurs, the SNMP manager may directly notify a content, which includes the emergency message, using an event handler, to a manager of the network element device through a manager connected to a local, or performs an operation of notifying the content to a computer, a wired terminal and a wireless terminal, etc., which are held by a remote control manager, through an Internet.

The Internet maybe an Internet protocol (IP) network, a public switched telephone network (PSTN) or a wireless network. In this example, the SNMP manager performs a notification operation to the remote control manager with an e-mail, a voice service or a mobile short message service (SMS).

As described above, when the important alarm or event occurs in the network element device and the SNMP agent transmits a message to the SNMP manager using an SNMP trap, a manager managing the device can confirm the message through a monitor or an alarm device such as a buzzer.

The application server may comprise a database in which the information required for operations of the notification filter, the event correlator and the event handler is stored.

Accordingly, an expert manager would need to continuously monitor a state of the alarm & event manager.

In other words, according to the network management method example outlined above, an expert manager always monitors through a management server managing an alarm and an event mainly, or the alarm or event stare is notified to the remote manager with a short message, i.e., a short message service or a short voice mail. However, it is impossible to be aware of states other than the one event notified and there is only a one-way notification informed by the event handler of the management server.

In addition, only few network managers can be aware of a performance diagnosis, a failure sensing and a change of a constituting variable, etc. for the network element device through the management server managing the alarm and event, and a serious failure can occur for a long time when the manager turns his or her eyes away from the monitor or leaves his or her seat. Further, for an error message to a personal terminal through a one-way notification, a simple error message only is shown and thus it is impossible to perceive a kind (type) of error with the received error message.

### SUMMARY OF THE INVENTION

It is, therefore, an object of the present invention to provide a network alarm management system and a method for managing a network alarm using the same capable of interactively performing a service, which uni-laterally notifies an alarm and an event occurrence in a network element device to a manager of the network element device, between the network element device and the manager.

It is an another object to provide a network alarm management system and a method for managing a network alarm using the same, wherein a manager of a network element device can receive information of an alarm and an event, which occurred in the network element device, in a form of voice or character data using a communication device anywhere without regard to places and then be interactively provided with detailed contents.

To achieve the above and other objects, there is provided a network alarm management system managing an event of an error occurring in a network, comprising: a network element device outputting the event information to notify a manager and outputting detailed processing information so as to guide the manager responding to a processing guide-requesting signal transmitted from the manager regarding the event information; and an alarm management device receiving the output event information and calling the manager to voice-guide the manager, receiving and outputting the processing guide-requesting signal from the manager to the network element device, and receiving the detailed processing information corresponding to the processing guide-requesting signal from the network element device and thus voice-guiding the manager.

Preferably, the alarm management device comprises a voice file providing section outputting a voice file stored corresponding to the detailed processing information output from the network element device, and an interactive voice responding section voice-guiding the manager with the event information output from the network element device and performing a voice guide for the manager on the basis of the voice file output from the voice file providing section.

Preferably, the voice file providing section comprises a voice file database in which the voice file corresponding to the detailed processing information is stored, a storage information table storing storage information about the voice file stored in the voice file database, and a voice file managing section detecting the storage information of the voice file stored corresponding to the detailed processing information from the storage information table, detecting a voice file from the voice file database according to the detected storage information and thus providing the detected voice file to the interactive voice responding section.

Preferably, the alarm management device further comprises a menu retrieving section having a key/menu table in which a processing key menu regarding the processing guide-requesting signal received from the manager is registered, detecting a processing key menu registered corresponding to the processing guide-requesting signal from the key/menu table and providing the detected processing key menu to the voice guide responding section; and a simple network management protocol (SNMP) managing section detecting an object identifier (OID) registered corresponding to the processing key menu from a key menu/OID table in which an OID of an operation corresponding to the processing key menu provided to the voice guide responding section is stored and outputting the detected OID to the network element device.

Thereby, the network element device detects operation processing information from the database having the operation processing information corresponding to the OID stored therein and providing the detected information to the voice file providing section, and the voice file providing section detects the voice file corresponding to the operation processing information and provides the detected voice file to the interactive voice responding section.

Preferably, the alarm management device further comprises a notification processing section determining whether the event information output from the network element device is notified to the manager or not, and a call list providing section detecting a call list from a database having the call list stored for calling to voice-guide the event information according to the determination of whether the event information is notified or not.

Preferably, the SNMP managing section outputs an SNMP set changing command to the network element device when it receives a signal of requesting a change of an internal structure of the network element device from the manager. At this time, the network element device changes an internal protocol structure according to the SNMP set changing command.

Meanwhile, in accordance with another embodiment of the invention, there is provided a network alarm management system managing an event of an error occurring in a network, comprising: a network element device outputting the event information to notify it to a manager and outputting expected detailed processing information corresponding to at least one of expected processing guide-requesting signals transmitted which can be requested corresponding to the event information by the manager; and an alarm management device receiving the output event information and calling the manager to voice-guide the manager, and when a processing guide-requesting signal about the event information is received from the manager, detecting detailed processing information corresponding to the processing guide-requesting signal from the expected detailed processing information output from the network element device receiving and thus voice-guiding the manager with the detected information.

Preferably, the alarm management device comprises a voice file providing section outputting a voice file of the detailed processing information corresponding to the processing guide-requesting signal from the expected detailed processing information output in the network element device, and an interactive voice responding section voice-guiding the manager with the event information output from the network element device and performing a voice guide for the manager on the basis of the voice file output from the voice file providing section.

Preferably, the voice file providing section comprises a voice file database in which the voice file corresponding to the expected detailed processing information is stored, a storage information table storing storage information about the voice file stored in the voice file database, an expected information storing section in which the expected detailed processing information output from the network element device is stored, and a voice file managing section detecting the detailed processing information corresponding to an object identifier (OID), which corresponds to the processing guide-requesting signal received from the manager, from the expected information storing section having the expected detailed processing information stored therein when the OID is input, detecting storage information of the voice file stored corresponding to the detected detailed processing information from the storage information table, detecting a voice file from the voice file database according to the detected storage information and outputting the detected voice file to the interactive voice responding section.

Preferably, the alarm management device further comprises a menu retrieving section having a key/menu table in which a processing key menu regarding the processing guide-requesting signal received from the manager is registered, detecting the processing key menu registered corresponding to the processing guide-requesting signal from the key/menu table and providing the detected processing key menu to the voice guide responding section; and a simple network management protocol (SNMP) managing section detecting an object identifier (OID) registered corresponding to the processing key menu from a key menu/OID table in which the OID of an operation corresponding to the processing key menu provided to the voice guide responding section is stored and outputting the detected OID to the voice file providing section.

Thereby, the voice file providing section detects the detailed processing information corresponding to the object identifier from the expected information storing section, and detects the voice file corresponding to the detected operation processing information, thereby providing the detected voice file to the voice responding section.

Preferably, the alarm management device further comprises a notification processing section determining whether the event information output from the network element device is notified to the manager or not, and a call list providing section detecting a call list from a database having the call list stored for calling to voice-guide the event information according to the determination of whether the event information is notified or not.

In accordance with another aspect of the invention, there is provided a method for managing a network alarm using a network alarm management system, comprising steps of: a) voice-guiding a manager with event information occurred in a network, and b) when a processing guide-requesting signal is received from the manager regarding the voice-guide of the event information, voice-guiding the manager with detailed processing information previously stored corresponding to the processing guide-requesting signal.

Preferably, the step of b) comprises sub-steps of receiving the processing guide-requesting signal regarding the voice guide of the event information from the manager, detecting the detailed processing information previously stored to correspond to the processing guide-requesting signal, detecting a voice file stored corresponding to the detected detailed processing information and interactively performing a voice guide for the manager on the basis of the detected voice file.

In accordance with another aspect of the invention, there is provided a method for managing a network alarm using a network alarm management system, comprising steps of: a) voice-guiding a manager with event information occurred in a network and creating expected detailed processing information corresponding to at least one of expected processing guide-requesting signals transmitted which can be requested corresponding to the event information by the manager and b) when a processing guide-requesting signal is received from the manager regarding the voice-guide of the event information, voice-guiding the manager with detailed processing information corresponding to the processing guide-requesting signal from the expected detailed processing information.

Preferably, the step of b) comprises sub-steps of receiving the processing guide-requesting signal regarding the voice guide of the event information from the manager, detecting the detailed processing information corresponding to the processing guide-requesting signal from the expected detailed processing information created in step of a), detecting a voice file stored corresponding to the detected detailed processing information and interactively performing a voice guide for the manager on the basis of the detected voice file.

According to the invention, contrary to a prior method of one-sidedly informing the manager of the alarm or event occurred in the network element device, it is set such that the network element device and the manager can interactively communicate with each other, so that the alarm is notified to the manager and it is possible to request detailed alarm contents related to the network element device at the same time. In addition, the alarm and event are notified through a communication device connected to a public switched telephone network or a mobile communication network and then a control operation is performed, so that it is possible to directly notify the alarm to the manager of the network element device at any time without regard to places,

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating an example of a network management server;

FIG. 2 is a block diagram illustrating a network alarm management system for managing an alarm and an event of a network element device according to a first embodiment of the invention;

FIG. 3 is a detailed block diagram showing a notification processing section of FIG. 2;

FIG. 4 is a detailed block diagram showing a structure of a voice file providing section of FIG. 2;

FIG. 5 is a block diagram illustrating a network alarm management system for managing an alarm and an event of a network element device according to a second embodiment of the invention;

FIG. 6 is a detailed block diagram showing a voice file providing section of FIG. 5;

FIG. 7 is a flow chart showing a first embodiment of a method for managing a network alarm using a network alarm management system of the invention; and

FIG. 8 is a flow chart showing a second embodiment of a method for managing a network alarm using a network alarm management system of the invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

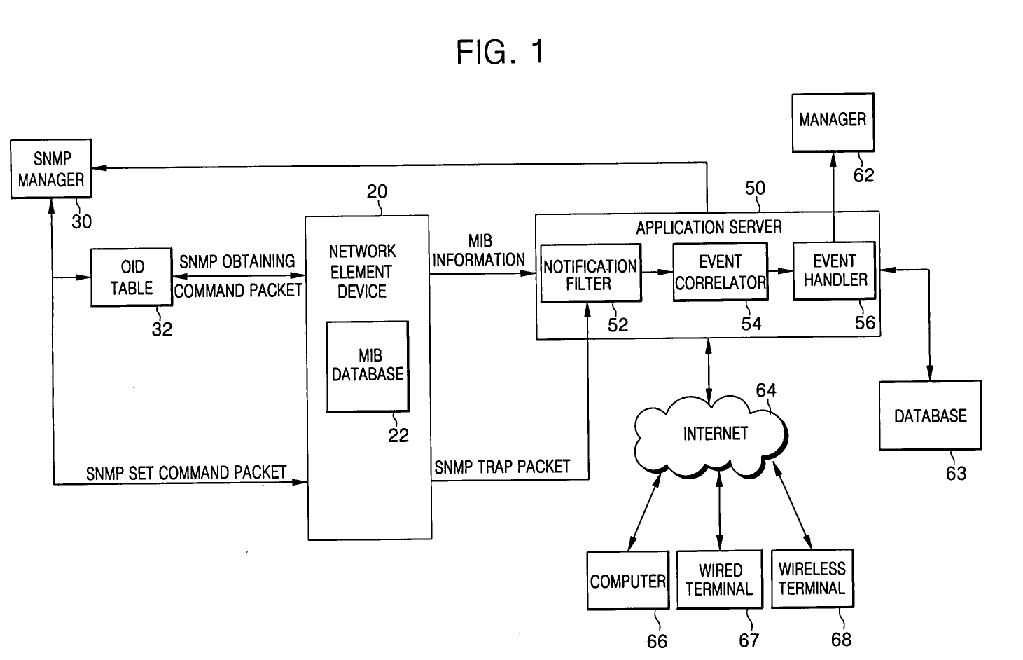

FIG. 1 is a block diagram illustrating an example of a network management server.

A network element device 20 in an Internet protocol (IP) environment supports a simple network management protocol (SNMP).

Generally, a management server for managing an alarm and event shown in FIG. 1 comprises an SNMP manager 30, and the network element device 20 consists of an SNMP agent.

The SNMP manager 30 uses a “get” command for periodically checking an alarm state or event of the SNMP agent, i.e., the network element device 20.

At this time, the SNMP manager 30 obtains a value using an object identifier (OID) table 32, in order to determine managed objects to be obtained using the SNMP “get” command. The OID is processed object information for performing a corresponding operation.

The network element device 20 manages specific objects that are arranged in a management information base (MIB) database 22, which is a virtual information database. The MIB describes detailed processing information about a processed object, or describes a set of managed objects, for which a corresponding operation is performed.

The network element device 20, from which the SNMP manager 30 requested the corresponding MIB information through the SNMP “get” command, transmits values of an alarm and an event to conform to an MIB format to a notification filter 52 of an application server 50 provided to the network management server. Some alarms that are not important or can be ignored are filtered in the notification filter 52. However, important alarms or events or continued alarms are transmitted to an event correlator 54.

In the correlator 54, a correlation of the alarm and the event is examined. At this time, when there is a further necessary alarm or event, the SNMP manager 30 again requests the MIB information from the network element device 20, which is an SNMP agent, using the “get” command.

Otherwise, when a predictable value or an emergency alarm or event occurs, the SNMP manager 30 directly notifies a content, which includes the emergency message, using an event handler 56, to a manager of the network element device through a manager 62 connected to a local, or performs an operation of notifying the content to a computer 66, a wired terminal 67 and a wireless terminal 68, etc., which are held by a remote control manager, through an Internet 64.

The Internet 64 may be an Internet protocol (IP) network, a public switched telephone network (PSTN) and a wireless network. In this case, the SNMP manager 30 performs a notification operation to the remote control manager with, for example, an e-mail, a voice service or a mobile short message service (SMS).

According to the foregoing, when the important alarm or event occurs in the network element device and the network element device 20, which is an SNMP agent, transmits a message to the SNMP manager 30 using an SNMP trap, a manager managing the device can confirm the message through a monitor or an alarm device such as a buzzer.

The application server 50 comprises a database 63 in which the information required for operations of the notification filter 52, the event correlator 54 and the event handler 56 is stored.

Accordingly, it is necessary that an expert manager continuously monitor a state of the alarm & event manager.

According to the invention, abnormal conditions of a network element device are provided in detail to a manager, who manages the network element device, through a communication device, such as a remote general phone or cellular phone connected to a public switched telephone network (PSTN) or an Internet communication network (hereinafter, referred to as Internet) such as a wireless network, or an Internet protocol (IP) device (for example: phone, computer, notebook) connected to an Internet network, as a menu layered with voice, at any time anywhere without regard to places, getting out of limited areas monitoring a system managing the network element device. In addition, according to the invention, there are proposed and disclosed, an interactive network alarm management system and a method for managing a network alarm using the same wherein a remote manager can request more specific alarm contents of alarms received through an Internet, according to a voice guide menu, and set up a constituting variable to remove an alarm providing service regarding an abnormal operation condition of a network element device.

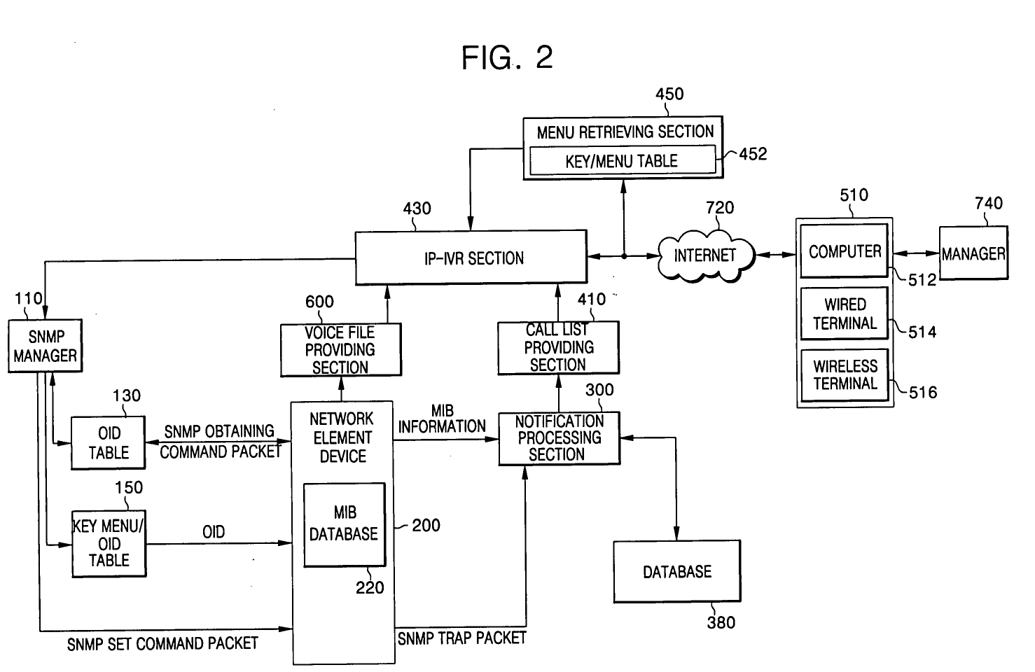

FIG. 2 is a block diagram illustrating a network alarm management system for managing an alarm and an event of a network element device according to a first embodiment of the invention.

As shown in FIG. 2, the network alarm management system comprises a simple network management protocol (SNMP) manager 110, a network element device 200, a notification processing section 300, a call list providing section 410, an Internet protocol-interactive voice response (IP-IVR) section 430, a menu retrieving section 450, a voice file providing section 600 and a database 380 in which data required for operating one of the parts provided is stored.

The SNMP manager 110 periodically obtains management information base (MIB) information of the network element device 200 using an SNMP Get command according to a scheduling of a self-managed object identifier (OID) table 130, in order to monitor an alarm and an event of the network element device 200.

When the network element device 200 receives the SNMP Get command from the SNMP manager 110, it collects the MIB information and transmits the collected information to the SNMP manager 110 using the SNMP, or it transmits the information to the notification processing section 300 using an SNMP trap packet when an emergency alarm or event internally defined occurs.

The notification processing section 300 receives the contents of the alarm and event from the network element device 200, determines whether the contents require notification or not and then transmits the determination to the call list providing section 410.

According to the notification determined in the notification processing section 300, the call list providing section 410 outputs a call list (a manager list of the network element device 200) for automatically calling up an appointed notifier (manager of an associated network element device) to the IP-IVR section 430.

Based on the manager list of the network element device 200 output from the call list providing section 410, the IP-IVR section 430 directly calls up a communication device 510 of a manager of a corresponding network element device connected through an Internet 720, and voice-guides the associated alarm or event contents. A computer 512, a wired terminal 514 and a wireless terminal 516 are shown only as an example of the communication device 510.

Preferably, when a key signal or short voice signal, which is input again through the communication device 510 by the manager of the network element device who was informed of the voice guide, is received, the IP-IVR section 430 stepwisely provides a detailed voice guide of a next stage of a menu corresponding to the signal to the manager.

When the key signal is input from the communication device 510, the menu retrieving section 450 retrieves a menu, which is set up corresponding to the key signal according to the voice guide at that time, with reference to a key/menu table 452 and then provides the retrieved menu to the IP-IVR section 430.

The IP-IVR section 430 provides menu information, which corresponds to the key signal provided from the menu retrieving section 450, to the SNMP manager 110. The SNMP manager 110 retrieves an OID (object identifier) registered corresponding to the menu information with reference to the key menu/OID table 150 and outputs the retrieved OID to the network element device 200 in a form of SNMP.

The network element device 200 detects MIB information, corresponding to the input OID, from an MIB database 220 and outputs the detected information to the voice file providing section 600.

The voice file providing section 600 detects a voice file constituting voice information, corresponding to the MIB information output from the MIB database 220 of the network element device 200, from a database provided in voice file providing section 600 and provides the detected voice file to the IP-IVR section 430. The voice file has a “VoiceXML” format.

The IP-IVR section 430 converts the voice file received from the voice file providing section 600 with a text-to-speech (TTS) program, which is an inherent function of the IVR, and performs an automatic output to a manager 740 through communication device 510 and Internet 720, thereby executing a voice guide about an operation error of the network element device 200.

Meanwhile, the IP-IVR section 430 guides the associated alarm or event contents to the communication device 510 as a hierarchical voice menu. At this time, manager 740, who was informed of the alarm through the voice guide, can request and receive a more specific alarm through the communication device 510. In addition, during the voice guide, manager 740 can perform a key button input of the communication device 510 or a short voice input (a number input by voice, for example, “one”, “two”) and thus be stepwisely provided with a voice guide of a next stage corresponding to the input, in order to set up a set changing command for setting up a parameter of a constituting variable according to the voice guide.

A one call session is formed between the IP-IVR section 430 having a call set up and the communication device 510 and continues to be maintained until the manager 740 disconnects the call by way of the communication device 510. A voice over IP (VoIP) function required for maintaining a continuous call signaling with the communication device 510 is embodied in the IP-IVR section 430 and the a voice gateway.

Meanwhile, when the manager 740, informed of the alarm contents, inputs a key button of the communication device 510 at any stage in which she, or he, is provided with the hierarchical voice menu, a key button-recognizing section is required. This is performed by a DTMF (Dual Tone Multi-Frequency) recognizing function which is an inherent function of the IP-IVR section 430 and the menu retrieving section 450 having the key/menu table 452 according to this embodiment of the invention. The menu corresponding to the input signal of the key button is a more specific menu or a message requesting a structure change of the network element device 200.

The SNMP manager 110 retrieves a corresponding OID value through the key menu/OID table 150 on the basis of the retrieved menu and requests an associated MIB information from the network element device 200 using an SNMP acquisition command or a change of a constituting variable from the network element device 200 using an SNMP set command.

The network element device 200, which received the OID value output from the key menu/OID table 150 through the SNMP, detects the corresponding MIB information from the MIB database 220 and outputs the detected information to the voice file providing section 600. In addition, the key menu/OID table 150 changes the constituting variable according to the SNMP set command.

Thereby, the voice file providing section 600 detects a corresponding voice file based on the MIB information provided from the network element device 200 and provides the detected voice file to the IP-IVR section 430. The IP-IVR section 430 guides a voice signal corresponding to the voice file to the communication device 510.

Accordingly, the manager 740 can perform an interactive management of the network element device 200 through the above-described processes.

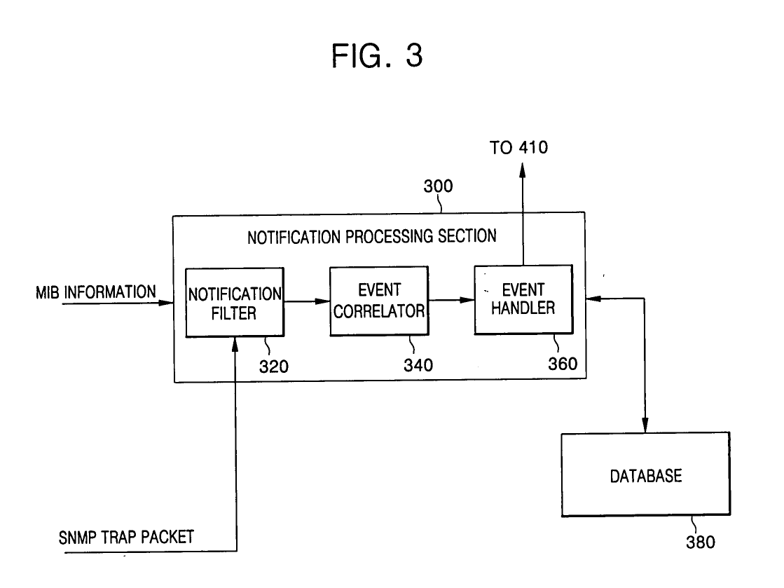

FIG. 3 is a detailed block diagram showing the notification processing section 300 of FIG. 2.

As shown in FIG. 3, the notification processing section 300 comprises an notification filter 320, an event correlator 340 and an event handler 360. At this time, the notification processing section 300 comprises a database 380 in which data required for operating one of the parts provided is stored.

The notification filter 320 performs a filtering process sorting out an important alarm or event from the alarms and events provided from the network element device 200.

The event correlator 340 analyzes a correlation of the alarm and event filtered and output from the notification filter 320 and then outputs an analysis result to the event handler 360.

The event handler 360 judges whether the alarm and event are emergent corresponding to a notification object, according to the analysis result output from the event correlator 340.

The call list providing section 410 creates a list for automatically calling up a previously set notifier 740 (manager of an associated network element device) from a database having telephone numbers of registered managers, according to the judgment result of the event handler 360. At this time, the call list providing section 410 outputs the created call list to the IP-IVR section 430 and updates it to its own database.

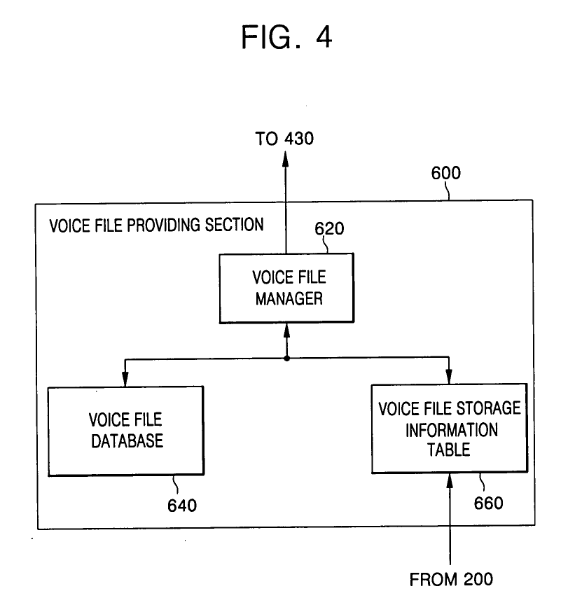

FIG. 4 is a detailed block diagram showing a structure of the voice file providing section 600 of FIG. 2.

As shown in FIG. 4, the voice file providing section 600 comprises a voice file database 640, a voice file storage information table 660, and a voice file manager 620.

A voice file corresponding to the MIB information is stored in the voice file database 640. The voice file storage information table 660 is provided with storage information, such as information of stored addresses regarding the voice files stored corresponding to the MIB information in the voice file database 540, as a table.

The voice file manager 620 detects the storage information of the voice file corresponding to the MIB information from the voice file storage information table 660, in order to find out a voice file for a voice guide corresponding to the MIB information provided from the network element device 200. Thereby, the voice file manager 620 detects the voice file from the voice file database 660 according to the detected storage information and provides the detected voice file to the IP-IVR section 430.

Meanwhile, the MIB information registered in the voice file storage information table 660 is a briefly abridged or arranged information of many OIDs and has a relevance matched with each OID.

The IP-IVR section 430 converts the voice file of“VoiceXML” format provided from the voice file manager 620 with the TTS program and then transmits the converted voice file to the Internet 720 in a form of packet.

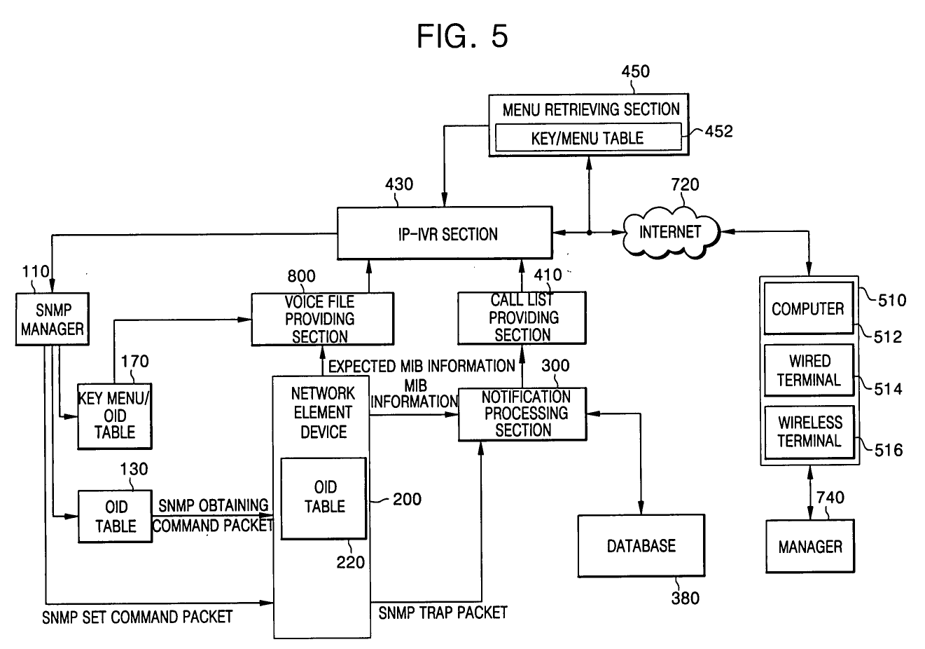

FIG. 5 is a block diagram illustrating a network alarm management system for managing an alarm and an event of a network element device according to a second embodiment of the invention.

For reference, when describing FIG. 5, an explanation of a block having a function overlapping with FIG. 2 is omitted.

According to the first embodiment of the invention shown in FIG. 2, since the network management system accesses the network element device 200 through the SNMP one by one whenever the key button is input by the manager 740 of the network element device 200, there is a worry that a voice guide of a corresponding menu provided to the current manager 740 of the network element device may be delayed.

The network alarm management system shown in FIG. 5 considers the above worry.

According to the network alarm management system shown in FIG. 2, whenever a key input signal according to a voice guide menu is again received from the manager of the network element device, the SNMP manager 110 finds an OID value through the key menu/OID table 150 on the basis of the corresponding menu and requests associated MIB information from the network element device 200 using the SNMP acquisition command.

According to the network alarm management system shown in FIG. 5, however, when an initial alarm or event occurs and the notification processing section 300 notifies the alarm to the call list providing section 410, all MIB information, which are expected to occur relating to the situation, are provided to a voice file providing section 800 from the network element device 200 at a time.

When a key signal requesting an associated voice guide is received during a call connection between the manager 740 having the communication device 510 and the IP-IVR section 430, the menu retrieving section 450 retrieves a menu corresponding to the received key signal and provides the retrieved menu to the SNMP manager 110 via the IP-IVR section 430.

The SNMP manager 110 detects an OID value corresponding to the menu provided from the IP-IVR section 430 from a key menu/OID table 170 and key menu/OID table 170 outputs the detected OID value to the voice file providing section 800.

The voice file providing section 800 detects MIB information corresponding to the input OID and a voice file corresponding to the detected MIB information and provides the detected voice file to the IP-IVR section 430.

Thereby, the IP-IVR section 430 performs a voice guide for the communication device 510 according to the input voice file.

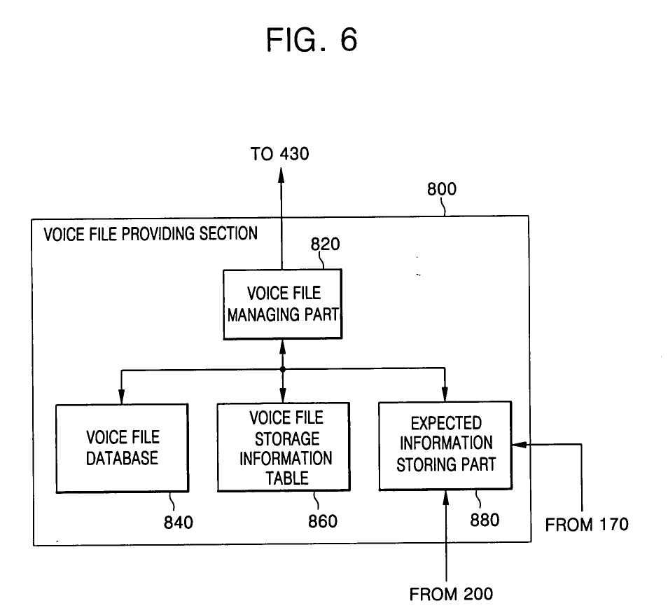

FIG. 6 is a detailed block diagram showing the voice file providing section 800 of FIG. 5.

As shown in FIG. 6, the voice file providing section 800 comprises a voice file database 840, a voice file storage information table 860, an expected information storing part 880 and a voice file managing part 820.

The voice file database 840 is provided with a voice file for a voice guide. The voice file storage information table 860 is provided with storage information about the voice file stored in the voice file database 840. The expected information storing part 880 is provided with expected MIB information provided from the network element device 200.

When an OID value is input from the key menu/OID table 170, the voice file managing part 820 detects MIB information corresponding to the input OID value from the expected information storing part 880. At this time, the voice file managing part 820 detects storage information of a voice file stored corresponding to the detected MIB information from the voice file storage information table 860, and then detects a voice file from the voice file database 840 according to the detected storage information, thereby providing the detected voice file to the IP-IVR section 430.

Thereby, the IP-IVR section 430 guides voice information corresponding to the provided voice file to the communication device 510. Accordingly, the network alarm management system can interactively manage a network alarm between the IP-IVR section 430 and the manager 740 of the network element device 200 without further need to pass through the network element device 200.

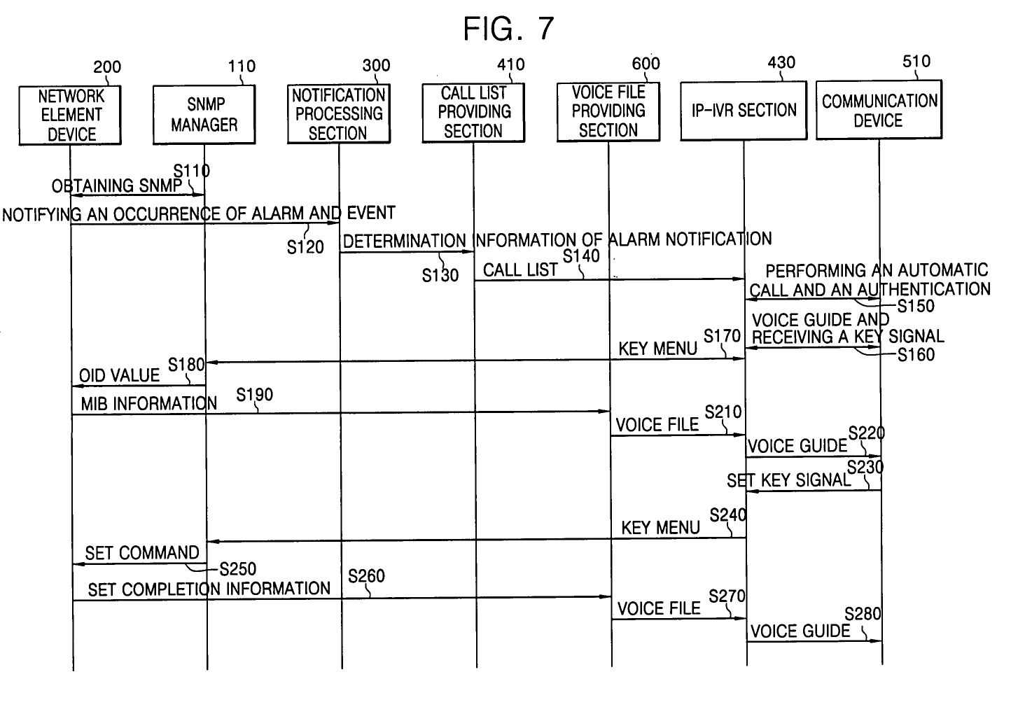

FIG. 7 is a flow chart showing a first embodiment of a method for managing a network alarm using a network alarm management system of the invention.

Hereinafter, the first embodiment of a method for managing a network alarm according to the invention will be described with reference to FIG. 2.

Firstly, the network element device 200 and the SNMP manager 110 perform an SNMP acquisition process (S110). When an alarm or event occurs by the network element device 200 itself or a monitoring of the SNMP manager 110, the network element device 200 informs the notification processing section 300 of an occurrence of the alarm and event through the MIB information or the SNMP trap packet (S120).

The notification processing section 300 determines whether the alarm and event are to be notified or not and provides the determination result to the call list providing section 410 (S130). The call list providing section 410 detects a registered call list and provides the detected list to the IP-IVR section 430 (S140).

The IP-IVR section 430 performs an automatic call on the basis of the provided call list and then an authentication about the communication device 510 of a corresponding manager (S150). When the authentication is completed, the IP-IVR section 430 performs a voice guide for the communication device 510 and receives a key signal input from the communication device 510 (S160).

When the key signal is received, the IP-IVR section 430 provides a key menu corresponding to the key signal detected by the menu retrieving section 450 to the SNMP manager 110 (S170). The SNMP manager 110 detects an OID value registered corresponding to the key menu from the key menu/OID table 150 and provides the detected value to the network element device 200 (S180).

The network element device 200 detects MIB information registered corresponding to the provided OID value from the MIB database 220 and then provides the detected information to the voice file providing section 600 (S190). The voice file providing section 600 detects a registered voice file corresponding to the provided MIB information and then provides the detected voice file to the IP-IVR section 430 (S210). Thereby, the IP-IVR section 430 performs a voice guide for the communication device 510 on the basis of the provided voice file (S220).

Meanwhile, when a signal requesting a change of a detailed menu retrieval about the voice guide previously provided or information previously set of the network element device 200 is received from the communication device 510 (S230), the IP-IVR section 430 receives a key menu registered corresponding to the received key signal from the menu retrieving section 450 and then provides the received key menu to the SNMP manager 110 (S240). At this time, the SNMP manager 110 retrieves a stored OID value corresponding to the key menu from the key menu/OID table 150 and provides the retrieved OID value to the network element device 200 if the provided key menu is a detailed menu retrieving menu, or provides an SNMP set changing command to the network element device 200 if the provided key menu is a set information changing menu (S250).

When the OID value is input, the network element device 200 retrieves MIB information corresponding to the input OID value and provides the retrieved information to the voice file providing section 600 (S1900), and the voice file providing section 600 detects a voice file stored corresponding to the provided MIB information and provides the detected voice file to the IP-IVR section 430 (S210). The IP-IVR section 430 performs a voice guide for the communication device 510 on the basis of the provided voice file (S220).

When the SNMP set changing command is input, the network element device 200 changes an internal structure variable and provides result information to the voice file providing section 600 (S260). When the result information of the internal structure change is received, the voice file providing section 600 detects a voice file corresponding to the received result information and provides the detected voice file to the IP-IVR section 430 (S270). The IP-IVR section 430 performs a voice guide for the communication device 510 on the basis of the provided voice file (S280).

The manager 740 of the network element device 510 can hang up through a specific button at any time while hearing the voice guide provided to the communication device 510 from the IP-IVR section 430 and store an operation specification for a masking process requesting an alarm interruption regarding a specified alarm and a history management or an opinion about an alarm in the database provided to the IP-IVR section 430.

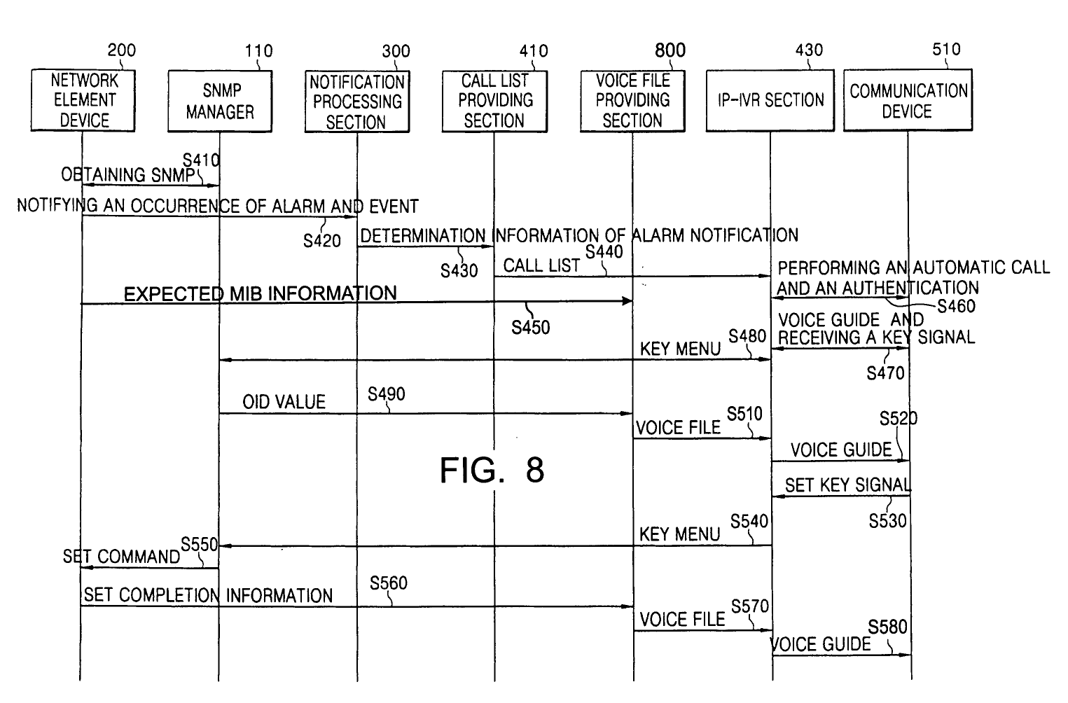

FIG. 8 is a flow chart showing a second embodiment of a method for managing a network alarm using a network alarm management system of the invention. The second embodiment of a method for managing a network alarm according to the invention will be described with reference to FIG. 5.

Firstly, the network element device 200 and the SNMP manager 110 perform an SNMP acquisition process (S410). When an alarm or event occurs by a monitoring of the network element device 200 itself or the SNMP manager 110, the network element device 200 informs the notification processing section 300 of an occurrence of the alarm and event through the MIB information or the SNMP trap (S420).

The notification processing section 300 determines whether the alarm and event are to be notified or not and provides the determination result to the call list providing section 410 (S430). The call list providing section 410 detects a registered call list and provides the detected list to the IP-IVR section 430 (S440).

At this time, the network element device 200 detects expected MIB information which can occur corresponding to the alarm and event information provided to the notification processing section 300, and provides the detected information to the voice file providing section 800 (S450).

The IP-IVR section 430 performs an automatic call on the basis of the provided call list and then an authentication about the communication device 510 of a corresponding manager (S460). When the authentication is completed, the IP-IVR section 430 performs a voice guide for the communication device 510 and receives a key signal input from the communication device 510 (S470).

When the key signal is received, the IP-IVR section 430 provides a key menu corresponding to the key signal detected by the menu retrieving section 450 to the SNMP manager 110 (S480). The SNMP manager 110 detects an OID value registered corresponding to the key menu from the key menu/OID table 170 and provides the detected value to the network element device 200 (S490).

The voice file providing section 800 detects a voice file registered corresponding to the provided OID value and then provides the detected voice file to the IP-IVR section 430 (S510). Thereby, the IP-IVR section 430 performs a voice guide for the communication device 510 on the basis of the provided voice file (S520).

When a signal of requesting a change of a detailed menu retrieval about the voice guide previously provided or information previously set of the network element device 200 is received (S530), the IP-IVR section 430 receives a key menu registered corresponding to the received key signal from the menu retrieving section 450 and then provides it to the SNMP manager 110 (S540). At this time, the SNMP manager 110 retrieves an OID value registered corresponding to the key menu from the key menu/OID table 170 and provides the retrieved OID value to the network element device 200 if the provided key menu is a detailed menu retrieving menu, and provides an SNMP set changing command to the network element device 200 if the provided key menu is a set information changing menu (S550).

When the OID value is input, the voice file providing section 800 detects a voice file corresponding to the input OID value and provides the detected voice file to the IP-IVR section 430. The IP-IVR section 430 performs a voice guide for the communication device 510 on the basis of the provided voice file.

When the SNMP set changing command is input, the network element device 200 changes an internal structure variable and provides result information to the voice file providing section 800 (S560). When the result information of the internal structure change is received, the voice file providing section 800 detects a voice file corresponding to the received information and provides the detected voice file to the IP-IVR section 430 (S570). The IP-IVR section 430 performs a voice guide for the communication device 510 on the basis of the provided voice file (S580).

As described above, according to the invention, contrary to the prior method of one-sidedly informing the manager of the alarm or event occurred in the network element device, it is set such that the network element device and the manager can interactively communicate with each other, so that the alarm is notified to the manager and it is possible to request detailed alarm contents related to the network element device at the same time.

In addition, the alarm and event are notified through a communication device connected to a public switched telephone network or a mobile communication network and then a control operation is performed, so that it is possible to directly notify the alarm to the manager of the network element device at any time without regard to places,

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. A network alarm management system managing an event of an error occurring in a network, comprising:
a network element device outputting event information to notify a manager of the event and outputting detailed processing information to guide the manager responding to a processing guide-requesting signal transmitted from the manager regarding the event information; and
an alarm management device receiving the output event information and calling the manager to voice-guide the manager, receiving and outputting the processing guide-requesting signal from the manager to the network element device, and receiving the detailed processing information corresponding to the processing guide-requesting signal from the network element device and thus voice-guiding the manager.

2. The system according to claim 1, wherein the alarm management device comprises:
a voice file providing section outputting a voice file stored corresponding to the detailed processing information output from the network element device; and
an interactive voice responding section voice-guiding the manager with the event information output from the network element device and performing a voice guide for the manager on the basis of the voice file output from the voice file providing section.

3. The system according to claim 2, wherein the voice file providing section comprises:
a voice file database in which the voice file corresponding to the detailed processing information is stored;
a storage information table storing storage information about the voice file stored in the voice file database; and
a voice file managing section detecting the storage information of the voice file stored corresponding to the detailed processing information from the storage information table, detecting a voice file from the voice file database according to the detected storage information and providing the detected voice file to the interactive voice responding section.

4. The system according to claim 3, wherein the alarm management device further comprises:
a menu retrieving section having a key/menu table in which a processing key menu regarding the processing guide-requesting signal received from the manager is registered, detecting a processing key menu registered corresponding to the processing guide-requesting signal from the key/menu table and providing the detected processing key menu to the voice guide responding section; and
a simple network management protocol (SNMP) managing section detecting an object identifier (OID) value registered corresponding to the processing key menu from a key menu/OID table in which an OID value of an operation corresponding to the processing key menu provided to the voice guide responding section is stored and outputting the detected OID value to the network element device,
whereby the network element device detects operation processing information from the database having the operation processing information corresponding to the OID value stored therein and providing the detected information to the voice file providing section, and the voice file providing section detects the voice file corresponding to the operation processing information and provides the detected voice file to the interactive voice responding section.

5. The system according to claim 4, wherein the alarm management device further comprises:
a notification processing section determining whether the event information output from the network element device is to be notified to the manager or not; and
a call list providing section detecting a call list from a database having the call list stored for calling to voice-guide the event information according to the determination of whether the event information is to be notified or not.

6. The system according to claim 5, wherein the SNMP managing section outputs an SNMP set changing command to the network element device when it receives a signal of requesting a change of an internal structure of the network element device from the manager, and the network element device changes an internal protocol structure according to the SNMP set changing command.

7. A network alarm management system managing an event of an error occurring in a network, comprising:
a network element device outputting the event information to notify a manager of the event and outputting expected detailed processing information corresponding to at least one of expected processing guide-requesting signals transmitted which can be requested corresponding to the event information by the manager; and
an alarm management device receiving the output event information and calling the manager to voice-guide the manager, and when a processing guide-requesting signal about the event information is received from the manager, detecting detailed processing information corresponding to the processing guide-requesting signal from the expected detailed processing information output from the network element device receiving and thus voice-guiding the manager with the detected information.

8. The system according to claim 7, wherein the alarm management device comprises:
a voice file providing section outputting a voice file of the detailed processing information corresponding to the processing guide-requesting signal from the expected detailed processing information output in the network element device, and
an interactive voice responding section voice-guiding the manager with the event information output from the network element device and performing a voice guide for the manager on the basis of the voice file output from the voice file providing section.

9. The system according to claim 8, wherein the voice file providing section comprises:
a voice file database in which the voice file corresponding to the expected detailed processing information is stored;
a storage information table storing storage information about the voice file stored in the voice file database;
an expected information storing section in which the expected detailed processing information output from the network element device is stored; and
a voice file managing section detecting the detailed processing information corresponding to an object identifier (OID) value, which corresponds to the processing guide-requesting signal received from the manager, from the expected information storing section having the expected detailed processing information stored therein when the OID value is input, detecting storage information of the voice file stored corresponding to the detected detailed processing information from the storage information table, detecting a voice file from the voice file database according to the detected storage information and outputting the detected voice file to the interactive voice responding section.

10. The system according to claim 9, wherein the alarm management device further comprises:
a menu retrieving section having a key/menu table in which a processing key menu regarding the processing guide-requesting signal received from the manager is registered, detecting the processing key menu registered corresponding to the processing guide-requesting signal from the key/menu table and providing the detected processing key menu to the voice guide responding section; and
a simple network management protocol (SNMP) managing section detecting an object identifier (OID) value registered corresponding to the processing key menu from a key menu/OID table in which the OID value of an operation corresponding to the processing key menu provided to the voice guide responding section is stored and outputting the detected OID value to the voice file providing section,
whereby the voice file providing section detects the detailed processing information corresponding to the object identifier from the expected information storing section, and detects the voice file corresponding to the detected operation processing information, thereby providing the detected voice file to the voice responding section.

11. The system according to claim 10, wherein the alarm management device further comprises:
a notification processing section determining whether the event information output from the network element device is to be notified to the manager or not; and
a call list providing section detecting a call list from a database having the call list stored for calling to voice-guide the event information according to the determination of whether the event information is to be notified or not.

12. The system according to claim 11, wherein the SNMP managing section outputs an SNMP set changing command to the network element device when it receives a signal of requesting a change of an internal structure of the network element device from the manager, and the network element device changes an internal protocol structure according to the SNMP set changing command.

13. A method for managing a network alarm using a network alarm management system, comprising steps of:
voice-guiding a manager with event information of event errors that have occurred in a network, and
voice-guiding the manager with detailed processing information previously stored corresponding to the processing guide-requesting signal, when a processing guide-requesting signal is received from the manager regarding the voice-guide of the event information.

14. The method according to claim 13, wherein the step of voice-guiding the manager with detailed processing information comprises sub-steps of:
receiving the processing guide-requesting signal regarding the voice guide of the event information from the manager;
detecting the detailed processing information previously stored to correspond to the processing guide-requesting signal;
detecting a voice file stored corresponding to the detected detailed processing information; and
interactively performing a voice guide for the manager on the basis of the detected voice file.

15. A method for managing a network alarm using a network alarm management system, comprising steps of:
voice-guiding a manager with event information of an event error occurring in a network and creating expected detailed processing information corresponding to at least one of expected processing guide-requesting signals transmitted which can be requested corresponding to the event information by the manager; and
voice-guiding the manager with detailed processing information corresponding to the processing guide-requesting signal from the expected detailed processing information when a processing guide-requesting signal is received from the manager regarding the voice-guide of the event information,.

16. The method according to claim 15, wherein the step of voice-guiding the manager with detailed processing information comprises sub-steps of:
receiving the processing guide-requesting signal regarding the voice guide of the event information from the manager;
detecting the detailed processing information corresponding to the processing guide-requesting signal from the expected detailed processing information created in step of voice-guiding a manager with event information;
detecting a voice file stored corresponding to the detected detailed processing information; and
interactively performing a voice guide for the manager on the basis of the detected voice file.
